(19) United States
(12) Patent Application Publication
(10) Pub. No.: US 2014/0123823 A1
(43) Pub. Date: May 8, 2014

(54) SLICING APPARATUS AND SLICING METHOD

(71) Applicant: Urschel Laboratories Inc., Valparaiso, IN (US)

(72) Inventor: Anthony A. McCracken, Dyer, IN (US)

(73) Assignee: Urschel Laboratories Inc., Valparaiso, IN (US)

(21) Appl. No.: 14/072,059

(22) Filed: Nov. 5, 2013

Related U.S. Application Data
(60) Provisional application No. 61/722,360, filed on Nov. 5, 2012.

(51) Int. Cl. B26D 7/06; B26D 3/30

(52) U.S. Cl. CPC B26D 7/0683; B26D 7/0625; B26D 3/30
USPC 83/23; 83/422; 83/373; 83/121; 83/56

(57) ABSTRACT

A slicing apparatus and method suitable for reliably slicing elongated food products along a longitudinal axis thereof. The apparatus includes a slicing wheel mounted for rotation about a roughly horizontal axis, a first delivery structure adapted to deliver food product to the slicing wheel, and a moving delivery device adapted to press the food product against the first delivery structure and propel the food product in a delivery direction along a length of the first delivery structure to the slicing wheel. The slicing wheel produces a slice cut in the food product parallel to the delivery direction in which the food product is delivered to the slicing wheel.

### CROSS REFERENCE TO RELATED APPLICATIONS

This application claims the benefit of U.S. Provisional Application No. 61/722,360, filed Nov. 5, 2012, the contents of which are incorporated herein by reference.

### BACKGROUND OF THE INVENTION

The present invention generally relates to methods and equipment for cutting food products. More particularly, this invention relates to a slicing apparatus suitable for slicing an elongate food product lengthwise.

Various types of equipment are known for slicing, dicing, shredding and granulating products, including but not limited to food products. A particular example is the TRANSLICER® series of machines manufactured by Urschel Laboratories, embodiments of which are disclosed in U.S. Pat. No. 6,148,702. The TRANSLICER® series has found wide use for slicing elongate products with the use of a cutting wheel disposed in a vertical plane and rotated on a horizontal axis, with radial cutting blades mounted between a hub and an annular-shaped rim. Notable examples of cutting wheels suitable for use with the TRANSLICER® are disclosed in commonly-assigned U.S. Pat. Nos. 5,992,284 and 6,148,709. A conveyor or other suitable device delivers product horizontally to the cutting wheel. The cutting operation performed by the TRANSLICER® is generally limited to the hemisphere of the cutting wheel in which the blades are traveling downward, because attempting to cut a product as the blade travels upward tends to lift the product off the conveyor.

Although the TRANSLICER® series of machines produce desirable resulting in various cutting applications, there is an ongoing demand for machines capable of producing various types of cuts.

### BRIEF DESCRIPTION OF THE INVENTION

The present invention provides a slicing apparatus capable of reliably slicing elongated food products, particularly along a longitudinal axis thereof.

According to a first aspect of the invention, a slicing apparatus includes a slicing wheel mounted for rotation about a roughly horizontal axis, a first delivery structure adapted to deliver a food product to the slicing wheel, and a moving delivery device adapted to press the food product against the first delivery structure and push the food product in a delivery direction along a length of the first delivery structure to the slicing wheel. The slicing wheel produces a slice cut in the food product parallel to the delivery direction in which the food product is delivered to the slicing wheel.

Other aspects of the invention include methods of using a slicing apparatus comprising the elements described above.

A technical effect of the invention is the ability to rapidly and reliably slice elongated food products lengthwise. In particular, it is believed that, by providing a moving delivery structure that is capable of applying pressure to the entire length of an elongate food product as it is being sliced with the slicing wheel, curvature of the food product can be minimized to the extent that the food product can be proportionately halved along its length.

Other aspects and advantages of this invention will be better appreciated from the following detailed description.

### BRIEF DESCRIPTION OF THE DRAWINGS

FIGS. 1 through 3 are perspective views representing a slicing apparatus in accordance with an aspect of this invention.

### DETAILED DESCRIPTION OF THE INVENTION

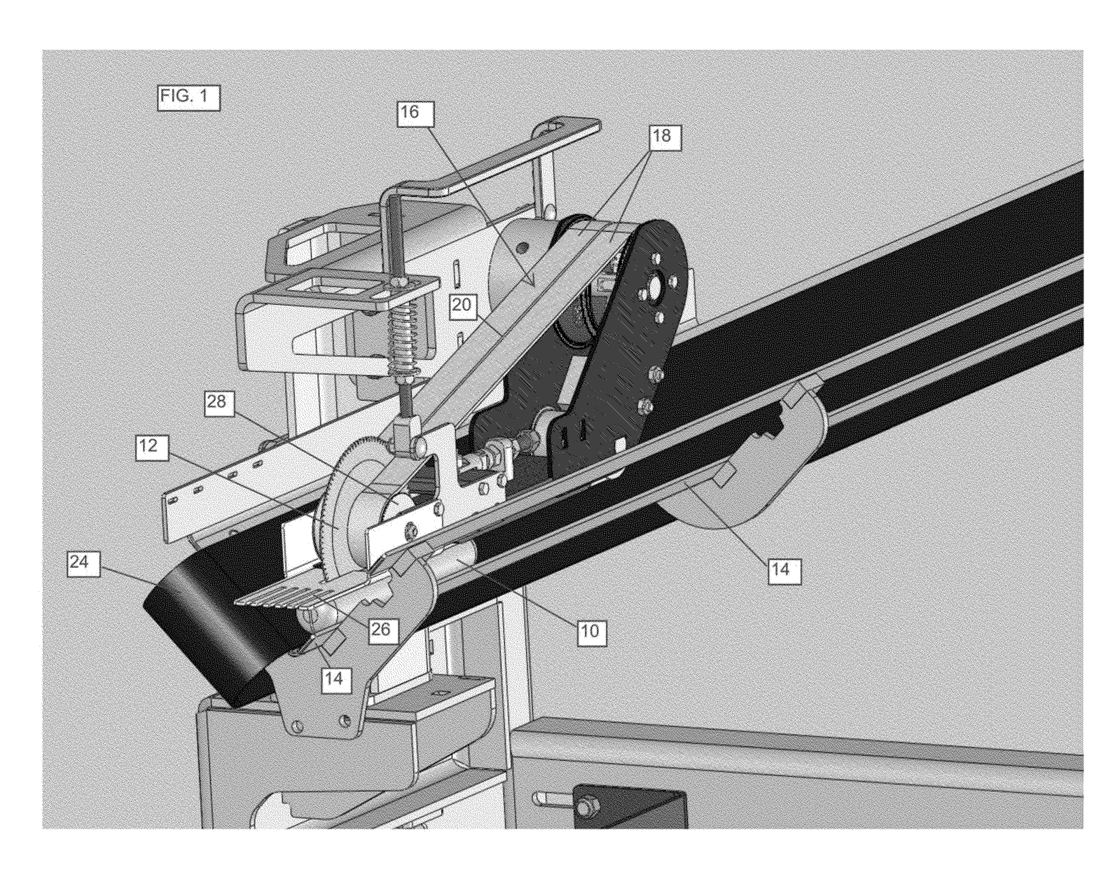

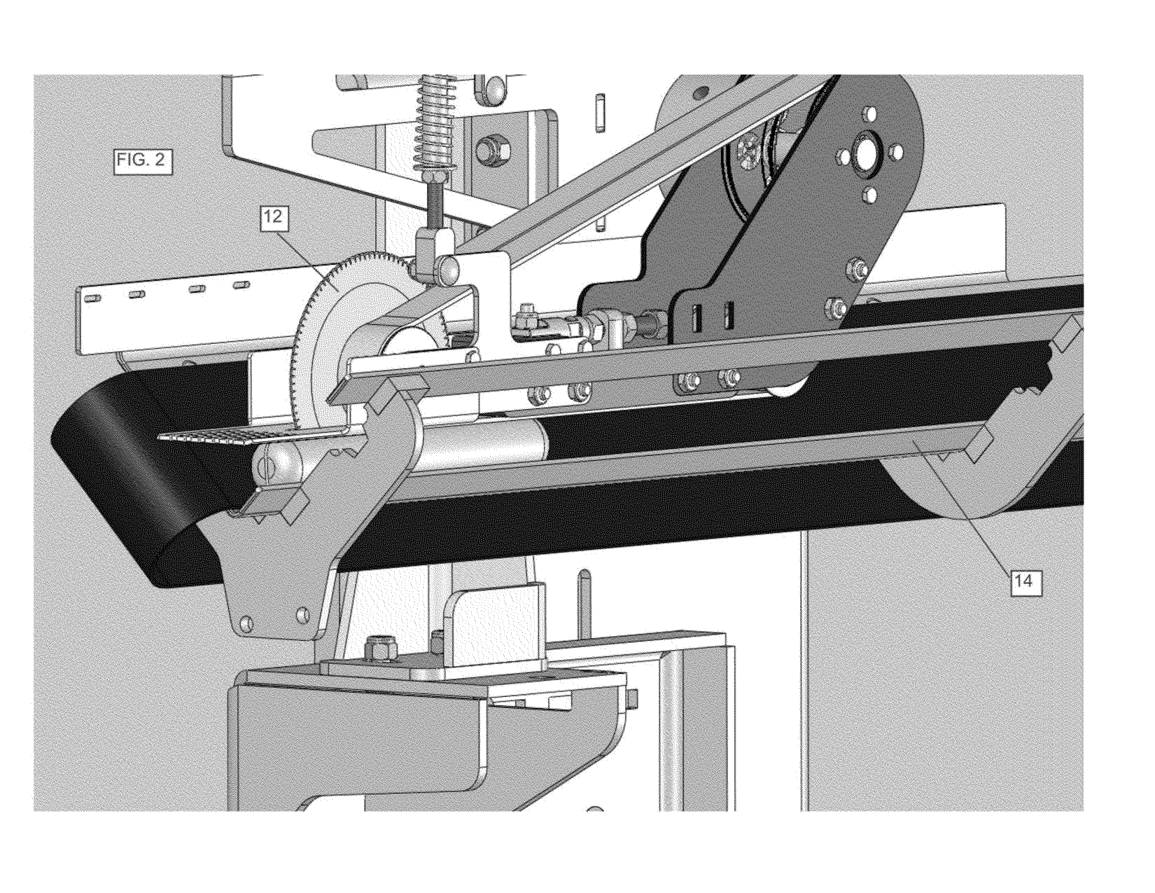

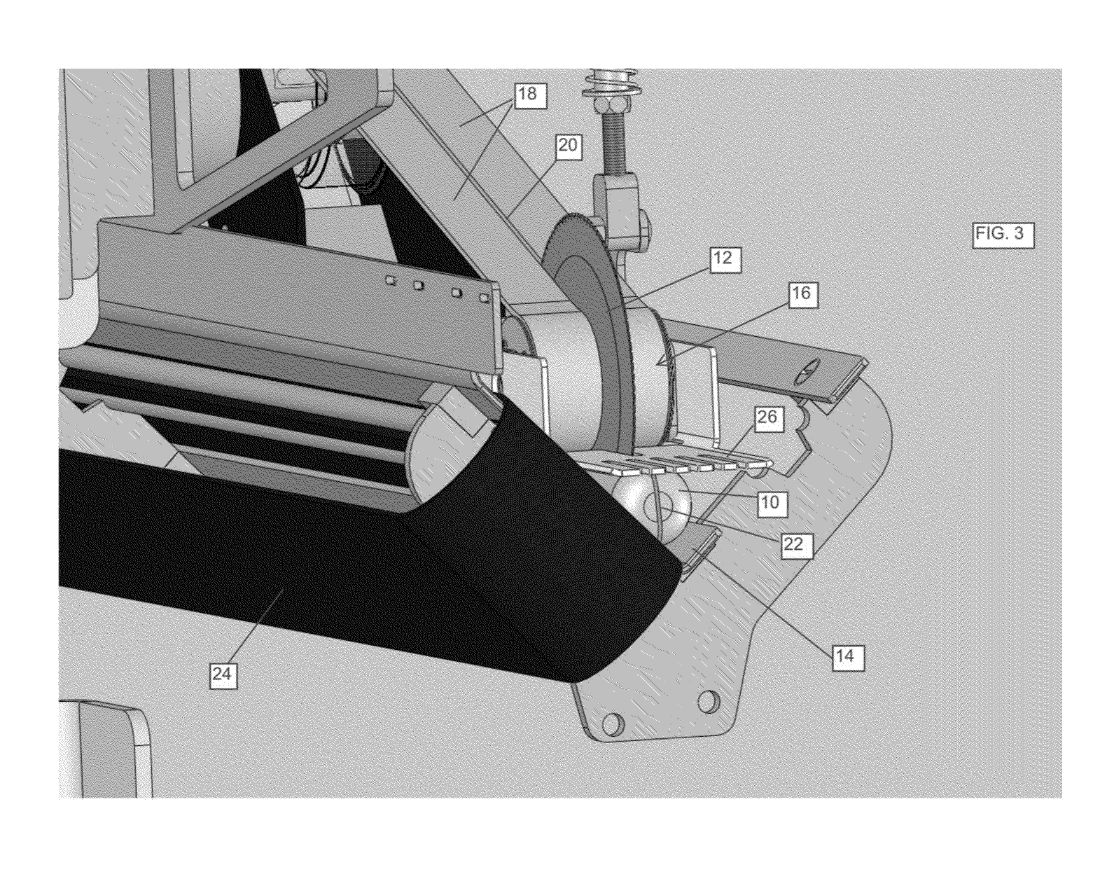

The present invention provides a slicing apparatus that may be, though is not required to be, a variation or adaptation of the TRANSLICER® series of machines. As schematically represented in FIGS. 1, 2 and 3, the slicing apparatus is well suited for slicing an elongate food product 10 with the use of a slicing wheel 12 disposed in a vertical plane and rotated on a horizontal axis, as the product 10 is horizontally delivered to the slicing wheel 10. In contrast to the radial cutting blades of the TRANSLICER® series, the slicing wheel 12 can be in the form of a disk-shaped blade oriented to produce a lengthwise slice cut 22 in the food product 10 as it is delivered horizontally to the slicing wheel 12. The embodiment of FIGS. 1 through 3 shows the product 10 as being delivered while supported on a channel 14 or another suitable stationary delivery structure, which operates in combination with an overhead hold-down device 16. The hold-down device 16 is represented as a conveyor belt unit in FIGS. 1 through 3, though other moving delivery devices could also be used. The channel 14 is further shown as having a V-shaped cross-sectional shape and operating in combination with a conveyor belt 24 that is supported by and travels on one of two legs of the V-shaped channel 14. In preferred embodiments, a second conveyor belt (not shown) rides on the second of the two legs of the V-shaped channel 14, such that the product 10 is entirely supported on two moving delivery devices (belts 24). However, it is also foreseeable that the product 10 could be supported solely by the stationary channel 14, or that only one belt 24 could be employed.

The wheel 12 can be seen to produce the slice cut 22 in the food product 10 parallel to the length of the product 10 and parallel to the direction in which the product 10 is delivered to the wheel 12 on the channel 14. In certain embodiments of the invention, the product 10 has a circular cross-section and the slice cut 22 is a diametrical cut that passes entirely through the product 10 so as to halve the product 10. However, the invention is not limited to any particular type of cut, for example, the slice cut 22 could lie on a chord of the circular cross-section of the product 10, or the product 10 could have a cross-section other than circular. FIGS. 1 through 3 depict the inclusion of an optional comb/stripper plate 26 adapted to maintain stability/control of the sliced product 10 as and after it leaves the wheel 12, particularly such that the product 10 continues its forward momentum as it exits the slicing apparatus.

The overhead hold-down device 16 can be seen to be an integral hold-down device that presses the product 10 against the channel 14 and/or belts 24, and simultaneously propels the product 10 along the length of the channel 14 into engagement with the wheel 12. As evident from FIGS. 1 through 3, the arrangement of the slicing wheel 12 and hold-down device 16 necessitates that the hold-down device 16 comprises at least two belts 18, at least one of which is to either side of the slicing wheel 12 so that the wheel 12 is able to rotate within a gap 20 between the belts 18 without interference from either belt 18. Suitable tensioning devices can be used to ensure proper operation of the hold-down device 16 in relation to the wheel 12 and channel 14.

From FIGS. 1 through 3, it can be seen that the speeds and positions of the slicing wheel 12 and hold-down device 16 can be synchronized by mounting the wheel 12 to one of the spindles 28 on which the belts 18 are mounted. With this configuration, the product delivery speed of the hold-down device 16 can be synchronized to the rotational speed of the wheel 12, and the slicing depth of the wheel 12 can be synchronized with the position of the hold-down device 16 as the latter applies a downward force to the product 10 and the product 10 is sliced by the wheel 12. The hold-down device 16 thereby serves to help maintain the correct speed of the product 10 as it travels through the wheel 12 and maximize product contact with the belts 18. In the embodiment shown in FIGS. 1 through 3, the belts 18 of the hold-down device 16 are sized for the particular product 10 so as to also apply pressure to the entire length of the product 10 as it is being sliced with the wheel 12. In this manner, curvature in the product 10 during the slicing operation can be minimized if not substantially eliminated, thereby promoting the ability of the wheel 12 to proportionately halve the product 10 along its entire longitudinal length. The hold-down device 16 also effectively serves as a stripper plate to hold the product 10 in place as it is being sliced by the wheel 12.

The term “halve” is used above to reflect the orientation and positioning of the slicing wheel 12 as shown in FIGS. 1 through 3, in which the slicing wheel 12 roughly bisects an angle defined by the legs of the V-shaped support surfaces defined by the channel 14 and/or belts 24 (or other suitable moving and/or stationary structures) so as to roughly halve the product 10 lengthwise. However, it should be understood that the wheel 12 could have different angular orientations relative to the channel 14. Further processing can be performed on the product downstream of the wheel 12, such as with cutting knives similar to the type employed by the TRANSLICER® series of machines. Additional possible features of the apparatus can be appreciated from FIGS. 1 through 3.

In view of the above description and FIGS. 1 through 3, it will be apparent that the invention further enables a process by which a food product 10 may be sliced by delivering or otherwise locating the food product 10 on the channel 14, and rotating the belts 18 and 24 on or alongside the channel 14 to deliver the food product 10 to the rotating wheel 12 for slicing. During this operation, the belts 18 of the hold-down device 16 are adapted to apply pressure to the food product 10, preferably along the entire length thereof, as the food product 10 is being sliced by the slicing wheel 12, so that the entire length of the food product 10 is firmly and entirely supported by the channel 14 during the slicing operation.

While the invention has been described in terms of a specific embodiment, it is apparent that other forms could be adopted by one skilled in the art. For example, the slicing apparatus and its individual components could differ in appearance and construction from the embodiment shown in the Figures, and the stationary channel 14 could be replaced by a conveyor or other moving delivery device. Therefore, the scope of the invention is to be limited only by the following claims.

1. A slicing apparatus comprising:
a slicing wheel mounted for rotation about a roughly horizontal axis;
a first delivery structure adapted to deliver food product to the slicing wheel; and
a moving delivery device adapted to press the food product against the first delivery structure and propel the food product in a delivery direction along a length of the first delivery structure to the slicing wheel;
wherein the slicing wheel produces a slice cut in the food product parallel to the delivery direction in which the food product is delivered to the slicing wheel.

2. The slicing apparatus of claim 1, wherein the first delivery structure comprises a channel having a V-shaped cross-sectional shape defined by two legs.

3. The slicing apparatus of claim 2, the first delivery structure further comprising at least one conveyor belt that is supported by and travels on a first of the two legs of the channel.

4. The slicing apparatus of claim 3, the first delivery structure further comprising at least a second conveyor belt that is supported by and travels on a second of the two legs of the channel.

5. The slicing apparatus of claim 2, the slicing wheel bisects an angle defined by the V-shaped cross-sectional shape defined by the two legs of the channel.

6. The slicing apparatus of claim 1, wherein the moving delivery device comprises a conveyor unit comprising at least first and second belts, at least one of which is to either side of the slicing wheel, and the slicing wheel rotates within a gap between the first and second belts.

7. The slicing apparatus of claim 6, wherein the slicing wheel and the first and second belts are mounted on a spindle to synchronize a delivery speed of the food product to a rotational speed of the slicing wheel.

8. The slicing apparatus of claim 1, further comprising a stripper plate adapted to maintain stability and control of the food product as and after the food product leaves the slicing wheel such that the food product continues a forward momentum upon exiting the slicing wheel.

9. A method of slicing a food product using the slicing apparatus of claim 1, the method comprising:
locating the food product onto the first delivery structure;
rotating the slicing wheel; and
slicing the food product by causing the first delivery structure to deliver the food product to the slicing wheel while operating the moving delivery device to apply a pressure to an entire length of the food product.

10. The method of claim 9, wherein the first delivery structure comprises a channel having a V-shaped cross-sectional shape defined by two legs, and the food product is supported by the channel during the slicing step.

11. The method of claim 10, wherein the first delivery structure further comprises at least one conveyor belt that is supported by and travels on a first of the two legs of the channel.

12. The method of claim 11, wherein the first delivery structure further comprises at least a second conveyor belt that is supported by and travels on a second of the two legs of the channel.

13. The method of claim 10, wherein the slicing wheel bisects an angle defined by the V-shaped cross-sectional shape defined by the two legs of the channel.

14. The method of claim 9, wherein the moving delivery device comprises a conveyor unit comprising at least first and second belts, at least one of which is to either side of the slicing wheel, and the slicing wheel rotates within a gap between the first and second belts.

15. The method of claim 14, wherein the slicing wheel and the first and second belts are mounted on a spindle, and the method comprises synchronizing a delivery speed of the food product to a rotational speed of the slicing wheel.

16. The method of claim 9, further comprising maintaining stability and control of the food product with a stripper plate as and after the food product leaves the slicing wheel such that the food product continues a forward momentum upon exiting the slicing wheel.

17. The method of claim 9, wherein the food product is elongated along the delivery direction and the slice cut is lengthwise in the food product.

18. The method of claim 17, wherein the slice cut is a diametrical cut that passes entirely through the food product so as to halve the food product.

19. A method of slicing a food product, the method comprising:
locating a food product onto a first delivery structure;
rotating a slicing wheel; and
slicing the food product by causing the first delivery structure to deliver the food product to the slicing wheel while operating a moving delivery device to apply a pressure to an entire length of the food product while the entire length of the food product is supported by the first delivery structure.

20. The method of claim 19, wherein the first delivery structure comprises a channel having a V-shaped cross-sectional shape defined by two legs, the first delivery structure further comprises at least one conveyor belt that is supported by and travels on a first of the two legs of the channel, and the method further comprises supporting the food product with the channel while transporting the food product with the conveyor belt during the slicing step.
